(19) United States
(12) Patent Application Publication
(10) Pub. No.: US 2026/0049261 A1
(43) Pub. Date: Feb. 19, 2026

(54) LAUNDRY COMPOSITION COMPRISING CARRAGEENAN, BENEFIT AGENT AND SODIUM CHLORIDE

(71) Applicant: Conopco, Inc., d/b/a UNILEVER, Hoboken, NJ (US)

(72) Inventors: Amanda Jane ADAMS, Wallasey (GB); Lee James BRENNAN, Widnes (GB); Karl BURGESS, Prenton, Wirral (GB); Andrew Paul CHAPPLE, Gwynfryn (GB); Peter GRAHAM, Upton (GB); Shah Faisal SYED, Kurnool (IN); Dhanalakshmi THIRUMENI, Bangalore (IN)

(73) Assignee: Conopco, Inc., d/b/a UNILEVER, Hoboken, NJ (US)

(21) Appl. No.: 19/103,716

(22) PCT Filed: Aug. 7, 2023
(86) PCT No.: PCT/EP2023/071860

§ 371 Date: Feb. 13, 2025

(30) Foreign Application Priority Data
Aug. 16, 2022 (IN) 202221046538
Oct. 7, 2022 (EP) 22200377.4

(51) Int. Cl. C11D 3/22; C11D 3/00; C11D 3/04; C11D 3/382; C11D 3/50; C11D 17/00; C11D 17/04

(52) U.S. Cl. CPC C11D 3/228; C11D 3/0021; C11D 3/046; C11D 3/382; C11D 3/505; C11D 17/003; C11D 17/043; C11D 2111/12

(57) ABSTRACT

A laundry composition comprising; hydrocolloid; benefit agent; salt; and water; wherein the salt comprises sodium chloride.

### FIELD OF THE INVENTION

The present invention is in the field of laundry compositions, particularly ancillary compositions suitable for delivering a benefit agent during the laundry process.

### BACKGROUND OF THE INVENTION

Consumers traditionally expect laundry detergents to clean their fabric and fabric conditioners to soften their fabrics. However, some consumers desire new or higher levels of benefit agents, such as perfumes or fabric care ingredients. At the same time, the fabrics in a consumers laundry baskets are becoming increasingly varied. Different fabrics require different benefit agents to keep them looking new and smelling fresh. Ancillary compositions are compositions designed to be used supplementary to traditional laundry detergents and fabric conditioners, to provide the desired additional benefits.

There is a need for an ancillary composition which can be used in addition to a traditional detergent or fabric conditioner, to delivery additional benefits. The ancillary composition must be sufficiently soluble to dissolve in a short period during the laundry cycle.

### SUMMARY OF THE INVENTION

It has been found that when a hydrocolloid gel matrix is used to deliver benefit agents during the laundry process, using sodium chloride salt for curing the gel provides improved dissolution during the laundry process.

Accordingly in a first aspect of the present invention is provided a laundry composition comprising;
a. Hydrocolloid comprising carrageenan;
b. Benefit agent;
c. Salt; and
d. Water;

Wherein the salt comprises sodium chloride.

In a further aspect of the present invention is provided a method of delivering benefit agents to fabric during the laundry process, wherein the laundry composition described herein is added to the laundry process.

In an additional aspect of the present invention is provided a use of the composition described herein to deliver benefit agents during the laundry process.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

When the “laundry composition” is referred to this is the final, cured product comprising the salt.

The laundry composition comprises a hydrocolloid comprising carrageenan. Hydrocolloids are polymers characterised by their property of forming viscous dispersions and/or gels when dispersed in water. “Hydrocolloids” (“hydrophilic colloids”) are macromolecules that have a largely linear shape and have intermolecular interaction forces that provide for secondary and main valence bonds between the individual molecules and thus provide for the formation of a net-like structure.

Hydrocolloids are natural or synthetic polymers that form gels or viscous solutions in aqueous systems. Hydrocolloids increase the viscosity of the water by either binding water molecules (hydration) or absorbing and enveloping the water in their interconnected macromolecules, while at the same time restricting the mobility of the water.

The hydrocolloid comprises carrageenan, more preferably the hydrocolloid comprises kappa carrageenan. Most preferably the hydrocolloid contains carrageenan, preferably kappa carrageenan.

Examples of suitable additional hydrocolloids include: fully synthetic compounds, such as polyacrylic and polymethacrylic compounds, vinyl polymers, polycarboxylic acids, polyethers, polyimines and polyamides, natural compounds, such as agar-agar, tragacanth, gum arabic, alginates, pectins, polyoses, guar flour, alginate, locust bean gum, starch, dextrins, gelatin, xanthan gum and casein, modified natural substances, such as carboxymethyl cellulose and other cellulose ethers, hydroxyethyl and hydroxypropyl cellulose, and inorganic compounds, such as polysilicic acids, clay minerals such as montmorillonites, zeolites and silicic acids.

Preferably the hydrocolloid of the present invention is derived from a natural source (modified or unmodified), i.e. vegetable (including seaweeds), animal or microbial derived polymers. In other words the hydrocolloid is isolated from vegetable sources (including seaweeds), animal sources or bacterial sources.

Preferred additional hydrocolloid comprises natural polymers selected from: agar, tragacanth, gum arabic, alginates, pectins, polyoses, guar flour, alginate, locust bean gum, starch, dextrins, gelatin and/or casein, xanthan gum, carboxymethyl cellulose and other cellulose ethers, hydroxyethyl and hydroxypropyl cellulose and combinations thereof.

The laundry compositions of the present invention preferably comprise 0.5 to 5 wt. % hydrocolloid by weight of the laundry composition, more preferably 1 to 3 wt. % hydrocolloid, most preferably 1.25 wt. % to 2.5 wt. % hydrocolloid by weight of the laundry composition.

The compositions described herein comprises sodium chloride. The composition may comprise one of more additional salts. Preferably the cation of the additional salt is selected from sodium, potassium, calcium, lithium and combinations thereof. Preferably the anion of the additional salt comprises chloride. More preferably the additional salt comprises salt selected from: potassium chloride, calcium chloride, lithium chloride and combinations thereof. Most preferably the additional salt comprises potassium chloride. The combination of sodium chloride and potassium chloride provide the optimal dissolution and product robustness.

The salt may be added directly to the composition neat or in a solution for example a salt water solution. Alternatively, the composition maybe dropped into a curing bath comprising the salt wherein the salt ‘cures’ the composition and becomes part of the composition.

The laundry compositions preferably comprise 0.00001 to 3 wt. % salt by weight of the laundry composition, more preferably 0.00005 to 2 wt. % salt, even more preferably 0.0001 to 1 wt. % salt, most preferably 0.0005 to 0.5 wt. % salt.

The compositions described herein comprise benefit agent(s). The benefit agents are ingredients which provide a beneficial effect to fabrics when delivered to the fabric during the laundry process. The benefit agents may aid in the cleaning of fabrics, may protect the fabrics from any form of damage (such a colour fade or abrasion to the fabrics) or may impart benefits to the fabrics such as anti-wrinkle, softening or perfuming.

Preferably the benefit agent may be selected from perfumes, perfume microcapsules, film forming polymers, fluorescers, dye-transfer inhibitors, natural oils, fabric softening actives, enzymes, shading dyes, antibacterial agents and combinations thereof.

The laundry compositions preferably comprise 0.5 to 50 wt. % benefit agent, more preferably 1 to 35 wt. % benefit agent, even more preferably 1.25 to 25 wt. % and most preferably 1.5 to 20 wt. % benefit agent by weight of the laundry composition.

The benefit agent may be dispersed through the laundry composition described herein. Alternatively, the benefit agent maybe encapsulated the hydrocolloid matrix. This may be preferable when the benefit agent is an oil or is in an organic solvent or carrier.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

5 Particularly preferred perfume components are blooming perfume components and substantive perfume components. Blooming perfume components are defined by a boiling point less than 250° C. and a Log P or greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The laundry compositions preferably comprise perfume microcapsules. suitable encapsulating materials, preferably comprise; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume microcapsules for use in the laundry compositions can be friable microcapsules and/or moisture activated microcapsules. By friable, it is meant that the perfume microcapsule will rupture when a force is exerted. By moisture activated, it is meant that the perfume is released in the presence of water. The laundry compositions preferably comprises friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials. Particularly preferred perfume components contained in a microcapsule are blooming perfume components and substantive perfume components. Blooming perfume components are defined by a boiling point less than 250° C. and a Log P greater than 2.5. Preferably the encapsulated perfume compositions comprises at least 20 wt. % blooming perfume ingredients, more preferably at least 30 wt. % and most preferably at least 40 wt. % blooming perfume ingredients. Substantive perfume components are defined by a boiling point greater than 250° C. and a Log P greater than 2.5. Preferably the encapsulated perfume compositions comprises at least 10 wt. % substantive perfume ingredients, more preferably at least 20 wt. % and most preferably at least 30 wt. % substantive perfume ingredients. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the laundry compositions it is preferable to have three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

Preferably the laundry compositions comprise film forming polymers. The film-forming polymers may be selected from synthetic organic polymers, natural polymers, modified natural polymers and combinations thereof.

Examples of suitable film forming polymers include: polyvinyl alcohol; polyvinyl pyrrolidone; polyethylene glycols; polyvinylpyrrolidones; polyacrylates including methacrylates; polyacrylamides; polymeric polycarboxylates such as water-soluble acrylate (co) polymers; ethoxylated hexamethylene diamine quaternary compounds; polyesters including copolyesters; polyurethanes; vinylpyrrolidone/vinyl ester copolymers; Polyquaternium polymers such as polyquaternium 1, 2, 4, 5, 6, 7, 8, 9, 10, 11, 12, 13, 14, 15, 16, 17, 18, 19, 20, 22, 24, 27, 28, 29, 30, 31, 32, 33, 34, 35, 36, 37, 39, 45, 46, 47, 48, 49, 50, 55, 56; siloxanes; polysaccharides such as starch, glucose, chitosan, gum arabic, xanthan, carrageenan; proteins such as collagen; modified starches; modified proteins such as hydrolysed proteins from animals, such as collagen, keratin and milk or from plants, such as wheat, corn, rice, potatoes, soybeans or almonds, from marine life forms, such as collagen, fish or algae or biotechnology-derived protein; polymers synthesised from plant materials such as rice bran soybean extract, cellulose derivatives such as carboxymethylcellulose, hydroxymethyl cellulose, methylcellulose, hydroxypropyl methylcellulose, hydroxycellulose, ethylcellulose, carboxymethyl cellulose, hydroxypropyl cellulose, nitrocellulose, cellulose acetate propionate and cellulose acetate butyrate; and combinations thereof.

The film forming polymer preferably has a weight-average molecular weight Mw in the range from 300 g/mol to 5,000,000 g/mol, preferably from 300 g/mol to 3,000,000 g/mol and more preferably from 500 g/mol to 2,000,000 g/mol. The average molecular weight Mw can be determined, for example, by gel permeation chromatography (GPC) (Andrews P., “Estimation of the Molecular Weight of Proteins by Sephadex Gel Filtration”; Biochem J., 1964, 91, pages 222 to 233). The use of protein hydrolysates with average molecular weights in this range leads to a particularly effective perfume benefit.

Preferred film forming polymer is selected from polymers comprising: polyvinyl alcohol; polyvinyl pyrrolidone; cellulose derivatives such as methylcellulose, hydroxypropyl methylcellulose, hydroxycellulose, ethylcellulose, carboxymethyl cellulose, hydroxypropyl cellulose; polyethylene glycol; polyethylene oxide; polysaccharides such as chitosan, gum arabic, xanthan, carrageenan; polyesters including co-polyesters; hydrolysed proteins or any combinations thereof. More preferably the film forming polymer is selected from polymers comprising: hydrolysed proteins or polyesters, including co-polyesters, polysaccharides.

Protein hydrolysates for use in the present invention are proteins which are obtainable by hydrolysis of proteins. Hydrolysis can be achieved by chemical reactions, in particular by alkaline hydrolysis, acid hydrolysis, enzymatic hydrolysis or combinations thereof. For alkaline or acid hydrolysis, methods such as prolonged boiling in a strong acid or strong base may be employed. For enzymatic hydrolysis, all hydrolytic enzymes are suitable, for example alkaline proteases. The production of protein hydrolysates are described, for example, by G. Schuster and A. Domsch in soaps and oils Fette Wachse 108, (1982) 177 and Cosm. Toil, respectively. 99, (1984) 63, by H. W. Steisslinger in Parf.Kosm. 72, (1991) 556 and F. Aurich et al. in Tens. Surf. Det. 29, (1992) 389 appeared.

The hydrolysed proteins of the present invention may come from a variety of sources. The proteins may be naturally sourced, e.g. from plants or animal sources, or they may be synthetic proteins. Preferably the protein is a naturally sourced protein or a synthetic equivalent of a naturally sourced protein. A preferred class of proteins are plant proteins, i.e. proteins obtained from a plant or synthetic equivalents thereof. Preferably the protein is obtained from a plant. Preferred plant sources include nuts, seeds, beans, and grains.

Particularly preferred plant sources are grains. Examples of grains include cereal grains (e.g. millet, maize, barley, oats, rice and wheat), pseudoceral grains (e.g. buckwheat and quinoa), pulses (e.g. chickpeas, lentils and soybeans) and oilseeds (e.g. mustard, rapeseed, sunflower seed, hemp seed, poppy seed, flax seed). Most preferred are cereal grains, in particular wheat proteins or synthetic equivalents to wheat proteins.

It is preferred that the protein hydrolyzate is cationically modified. Preferably, a cationically modified wheat protein hydrolysate. Preferably the hydrolyses protein is a quaternised protein. Preferably the hydrolysed protein contains at least one radical of the formula:

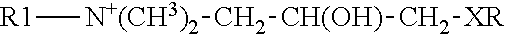

R1 is an alkyl group having 1 to 30 carbon atoms, an alkenyl group having 1 to 30 carbon atoms, or a hydroxyalkyl group having 1 to 30 carbon atoms. R1 is preferably selected from, a methyl group, a C 10-18 alkyl, or a C 10-13 alkenyl group, X is O, N or S.

R represents the protein residue. The term “protein residue” is to be understood as meaning the backbone of the corresponding protein hydrolyzate formed by the linking of amino acids, to which the cationic group is bound.

The cationization of the protein hydrolysates with the above-described residues can be achieved by reacting the protein hydrolyzates, in particular the reactive groups of the amino acids of the protein hydrolysates, with halides which otherwise correspond to compounds of the above formula (wherein the X—R moiety is replaced by a halogen).

The hydrolysed protein may be protein-silicone copolymer. The silicone component may be covalently bonded to amino groups of the protein groups. Silicone components may form cross-links between different protein chains. The protein component of a protein-silicone copolymer may represent from 5 to 98% by weight of the copolymer, more preferably from 50 to 90%. Preferably, the silicone component is organofunctional silane/silicone compounds. The protein-silicone copolymer may be prepared by covalently attaching organofunctional silane/silicone compounds to the protein amino groups to form larger polymer molecules including protein cross-linking. In addition, further polymerisation may occur through condensation of silanol groups and such further polymerisation increases the amount of cross-linking. The organofunctional silicone compounds used for reaction with the protein component to form the copolymer must contain a functional group capable of reacting with the chain terminal and/or side chain amino groups of the protein. Suitable reactive groups include, for example, acyl halide, sulphonyl halide, anhydride, aldehyde and epoxide groups. The silicone component may be any compound which contains a siloxane group (Si—O—Si) or any silane capable of forming a siloxane in situ by condensation of silanol (Si—OH) groups or any alkoxysilane or halosilane which hydrolyses to form a corresponding silanol and then condenses to form a siloxane group. Wheat protein hydrolysates are commercially available, for example, from Croda under the trade name Coltide Radiance.

Polyester polymers for use in the invention may include a variety of charged (e.g. anionic) as well as non-charged monomer units and structures may be linear, branched or star-shaped. The polyester structure may also include capping groups to control molecular weight or to alter polymer properties such as surface activity.

Polyesters for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units. Examples of such materials include oligomeric esters produced by transesterification/oligomerization of poly (ethyleneglycol) methyl ether, dimethyl terephthalate (“DMT”), propylene glycol (“PG”) and poly (ethyleneglycol) (“PEG”); partly- and fully-anionic-end-capped oligomeric esters such as oligomers from ethylene glycol (“EG”), PG, DMT and Na-3,6-dioxa-8-hydroxyoctanesulfonate; nonionic-capped block polyester oligomeric compounds such as those produced from DMT, Me-capped PEG and EG and/or PG, or a combination of DMT, EG and/or PG, Me-capped PEG and Na-dimethyl-5-sulfoisophthalate, and copolymeric blocks of ethylene terephthalate or propylene terephthalate with polyethylene oxide or polypropylene oxide terephthalate. Suitable polyesters can be obtained from Clariant under the trade name Texcare®.

Preferred polyesters for use in the invention include copolyesters formed by condensation of terephthalic acid ester and diol, preferably 1,2 propanediol, and further comprising an end cap formed from repeat units of alkylene oxide capped with an alkyl group. Examples of such materials have a structure corresponding to general formula:

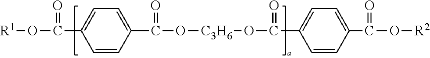

in which R¹ and R² independently of one another are X—(OC₂H₄)ₙ—(OCH₆)ₘ;

in which X is C₁₋₄ alkyl and preferably methyl;

n is a number from 12 to 120, preferably from 40 to 50;

m is a number from 1 to 10, preferably from 1 to 7; and

a is a number from 4 to 9.

Because they are averages, m, n and a are not necessarily whole numbers for the polymer in bulk.

Mixtures of any of the above described materials may also be used.

Preferably, the laundry composition comprises a fluorescer. More preferably, the fluorescer comprises a sulphonated distyrylbiphenyl fluoscers such as those discussed in Chapter 7 of Industrial Dyes (K. Hunger ed, Wiley VCH 2003).

Sulfonated distyrylbiphenyl fluorescer are discussed in U.S. Pat. No. 5,145,991 (Ciba Geigy). 4,4′-distyrylbiphenyl are preferred. Preferably the fluorescer contains 2 SO3- groups. Most preferably the fluorescer is of the structure:

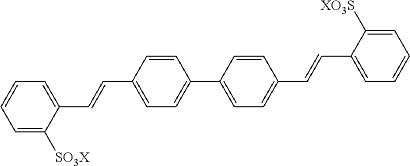

Where X is suitable counter ion, preferably selected from metal ions, ammonium ions, or amine salt ions, more preferably alkali metal ions, ammonium ions or amine salt ions, most preferably Na or K.

Where present, the composition preferably comprises 0.0001 to 10 wt. % fluorescer, more preferably 0.001 to 5 wt. %, most preferably 0.005 to 2 wt. % fluorescer by weight of the composition.

The laundry compositions preferably comprise dye transfer inhibitors. The dye transfer inhibitor is more preferably selected from the group comprising polyvinyl pyrrolidone (PVP), polyvinyl imidazole (PVI), copolymers of vinyl pyrrolidone and vinyl imidazole (PVP/PVI), polyvinylpyridine-N oxide, poly-N-carboxymethyl-4-wnylpyndium chloride, polyethylene glycol-modified copolymers of vinyl pyrrolidone and vinyl imidazole, 25 and mixtures thereof. These compounds form particularly stable complexes with the dyes detached from the textiles and can also be easily incorporated in a stable manner into a liquid detergent or cleaning agent with a low content of water.

The dye transfer inhibitor is preferably a polymer or copolymer of cyclic amines, such as vinyl pyrrolidone and/or vinyl imidazole. As dye transfer inhibitor, suitable polymers include polyvinyl pyrrolidone (PVP), polyvinylimidazole (PVI), copolymers of vinyl pyrrolidone and vinyl imidazole (PVP/PVI), polyvinylpyridine-N-oxide, poly-N-carboxymethyl-4-vinylpyridium chloride, polyethylene glycol-modified copolymers of vinyl pyrrolidone and vinyl imidazole, and mixtures thereof. Polyvinyl pyrrolidone (PVP), polyvinylimidazole (PVI) or copolymers of vinyl pyrrolidone and vinyl imidazole (PVP/PVI) are particularly preferably used as dye transfer inhibitor. The used polyvinyl pyrrolidones (PVP) preferably have an average molecular weight from 2,500 to 400,000, and are commercially available from ISP Chemicals as PVP K 15, PVP K 30, PVP K 60 or PVP K 90, or from BASF as Sokalan (R) HP 50 or Sokalan (R) HP 53. The used copolymers of vinyl pyrrolidone and vinyl imidazole (PVP/PVI) preferably have a molecular weight in the range from 5,000 to 100,000. A PVP/PVI copolymer is commercially available by way of example from BASF under the name Sokalan (R) HP 56. A further dye transfer inhibitor that can be used in an extremely preferred manner is provided by polyethylene glycolmodified copolymers of vinyl pyrrolidone and vinyl imidazole, which for example are obtainable under the name Sokalan (R) HP 66 from BASF.

The laundry compositions preferably comprise natural oils. Natural oils preferably comprise plant oils or the esterified fatty acids of plant oils. Natural oils exclude mineral oils derived from petroleum. Preferably the natural oil is a liquid or soft solid.

Plant oils include vegetable (e.g. olive oil), nut and seed oils. Plant oils also include microbial oils, which are oils produced by microbes or other organisms, including algal oils and including genetically modified or engineered microbes that produce oils. Plant oils preferably include triglycerides, free fatty acids, or a combination of both.

Preferably the natural oil comprises seed oils or the esterified fatty acids thereof. Seed oils include almond, argan, babassu, borage, camelina, Canola®, castor, chia, cherry, coconut, corn, cotton, coffee, Cuphea viscosissima, flax (linseed), grape, hemp, hepar, jatropha, jojoba, Lesquerella fendleri oil, Moringa oleifera oil, macadamia, mango, mustard, neem, oil palm, perilla, rapeseed, safflower, sesame, shea, stillingia, soybean, sunflower, tonka bean, tung.

The natural oil may comprise a triglyceride or mixtures of triglycerides with varying degrees of alkyl chain length and unsaturation. Each triglyceride comprises one or two or more, preferably three fatty acids, bonded by a glycerol bridge.

Preferably the natural oil comprises an ester oil. Ester oils are the esterified fatty acids of any of the above oils. The glycerides (of the above oils) are first hydrolysed to release fatty acids from the glycerol moiety, and then the fatty acids are then reacted with alcohols (mono-, di-, tri-, tetra, etc.,) to form an ester oil. Preferably the natural oil comprises esterified fatty acids of seed oils.

Preferably, the ester oil is a polyol ester (i.e. more than one alcohol group is reacted to form the polyol ester). Preferably the polyol ester is formed by esterification of a polyol (i.e. reacting a molecule comprising more than one alcohol group with acids). Preferably the polyol ester comprises at least two ester linkages. Preferably the polyol ester comprises no hydroxyl groups. Preferably the ester oil is a pentaerythritol e.g. a pentaerythritol tetraisostearate. Exemplary structures of the compound are (I) and (II) below:

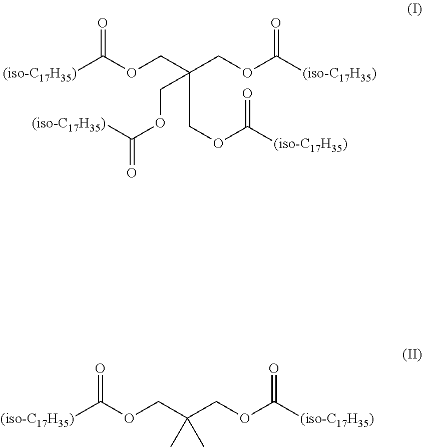

Preferably the ester oil is saturated.

Preferably, the ester oils are esters containing straight or branched, saturated or unsaturated carboxylic acids.

Suitable ester oils are the fatty ester of a mono or polyhydric alcohol having from 1 to about 24 carbon atoms in the hydrocarbon chain and mono or polycarboxylic acids having from 1 to about 24 carbon atoms in the hydrocarbon chain with the proviso that the total number of carbon atoms in the ester oil is equal to or greater than 16 and that at least one of the hydrocarbon radicals in the ester oil has 12 or more carbon atoms.

Preferably the viscosity of the natural oil is from 2 mPa·s to 400 mPa·s at a temperature of 25 C, more preferably a viscosity from 2 to 150 mPa·s, most preferably a viscosity from 10 to 100 mPa·s.

Preferably the refractive index of the natural oil is from 1.445 to 1.490, more preferred from 1.460 to 1.485.

The natural oil of the current invention may be in the form of a free oil or an emulsion. The natural oil may be encapsulated. Suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

The laundry compositions preferably comprise fabric softening actives. The fabric softening actives may be any material known to soften fabrics. These may be polymeric materials or compounds known to soften materials. Examples of suitable fabric softening actives include: quaternary ammonium compounds, silicone polymers, polysaccharides, clays, amines, fatty esters, dispersible polyolefins, polymer latexes and mixtures thereof.

The fabric softening actives may preferably be cationic or non-ionic materials. Preferably, the fabric softening actives of the present invention are cationic materials. Suitable cationic fabric softening actives are described herein.

The preferred softening actives for use in fabric conditioner compositions of the invention are quaternary ammonium compounds (QAC).

The QAC preferably comprises at least one chain derived from fatty acids, more preferably at least two chains derived from a fatty acid. Generally fatty acids are defined as aliphatic monocarboxylic acids having a chain of 4 to 28 carbons. Fatty acids may be derived from various sources such as tallow or plant sources. Preferably the fatty acid chains are derived from plants. Preferably the fatty acid chains of the QAC comprise from 10 to 50 wt. % of saturated C18 chains and from 5 to 40 wt. % of monounsaturated C18 chains by weight of total fatty acid chains. In a further preferred embodiment, the fatty acid chains of the QAC comprise from 20 to 40 wt. %, preferably from 25 to 35 wt. % of saturated C18 chains and from 10 to 35 wt. %, preferably from 15 to 30 wt. % of monounsaturated C18 chains, by weight of total fatty acid chains.

The preferred quaternary ammonium fabric softening actives for use in compositions of the present invention are ester linked quaternary ammonium compounds or so called “ester quats”. Particularly preferred materials are the ester-linked triethanolamine (TEA) quaternary ammonium compounds comprising a mixture of mono-, di- and tri-ester linked components.

Typically, TEA-based fabric softening compounds comprise a mixture of mono, di- and tri ester forms of the compound where the di-ester linked component comprises no more than 70 wt. % of the fabric softening compound, preferably no more than 60 wt. % e.g. no more than 55%, or even no more that 45% of the fabric softening compound and at least 10 wt. % of the monoester linked component.

A first group of quaternary ammonium compounds (QACs) suitable for use in the present invention is represented by formula:

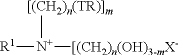

wherein each R is independently selected from a C5 to C35 alkyl or alkenyl group; R1 represents a C1 to C4 alkyl, C2 to C4 alkenyl or a C1 to C4 hydroxyalkyl group; T may be either O—CO. (i.e. an ester group bound to R via its carbon atom), or may alternatively be CO—O (i.e. an ester group bound to R via its oxygen atom); n is a number selected from 1 to 4; m is a number selected from 1, 2, or 3; and X-is an anionic counter-ion, such as a halide or alkyl sulphate, e.g. chloride or methylsulfate. Di-esters variants of formula I (i.e. m=2) are preferred and typically have mono- and tri-ester analogues associated with them. Such materials are particularly suitable for use in the present invention.

Also suitable are actives rich in the di-esters of triethanolammonium methylsulfate, otherwise referred to as “TEA ester quats”.

A second group of QACs suitable for use in the invention is represented by formula:

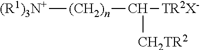

wherein each R1 group is independently selected from C1 to C4 alkyl, hydroxyalkyl or C2 to C4 alkenyl groups; and wherein each R2 group is independently selected from C8 to C28 alkyl or alkenyl groups; and wherein n, T, and X— are as defined above.

Preferred materials of this second group include 1,2 bis[tallowoyloxy]-3-trimethylammonium propane chloride, 1,2 bis[hardened tallowoyloxy]-3-trimethylammonium propane chloride, 1,2-bis[oleoyloxy]-3-trimethylammonium propane chloride, and 1,2 bis[stearoyloxy]-3-trimethylammonium propane chloride. Such materials are described in U.S. Pat. No. 4,137,180 (Lever Brothers). Preferably, these materials also comprise an amount of the corresponding monoester.

A third group of QACs suitable for use in the invention is represented by formula:

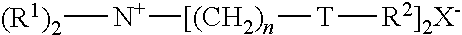

wherein each R1 group is independently selected from C1 to C4 alkyl, or C2 to C4 alkenyl groups; and wherein each R2 group is independently selected from C8 to C28 alkyl or alkenyl groups; and n, T, and X— are as defined above. Preferred materials of this third group include bis (2-tallowoyloxyethyl) dimethyl ammonium chloride, partially hardened and hardened versions thereof.

A particular example of the fourth group of QACs is represented the by the formula:

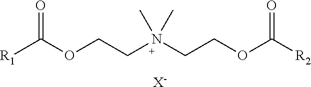

A fourth group of QACs suitable for use in the invention are represented by formula:

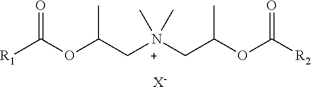

R1 and R2 are independently selected from C10 to C22 alkyl or alkenyl groups, preferably C14 to C20 alkyl or alkenyl groups. X-is as defined above.

The iodine value of the quaternary ammonium fabric conditioning material is preferably from 0 to 80, more preferably from 0 to 60, and most preferably from 0 to 45. The iodine value may be chosen as appropriate. Essentially saturated material having an iodine value of from 0 to 5, preferably from 0 to 1 may be used in the compositions of the invention. Such materials are known as “hardened” quaternary ammonium compounds.

A further preferred range of iodine values is from 20 to 60, preferably 25 to 50, more preferably from 30 to 45. A material of this type is a “soft” triethanolamine quaternary ammonium compound, preferably triethanolamine di-alkylester methylsulfate. Such ester-linked triethanolamine quaternary ammonium compounds comprise unsaturated fatty chains.

If there is a mixture of quaternary ammonium materials present in the composition, the iodine value, referred to above, represents the mean iodine value of the parent fatty acyl compounds or fatty acids of all of the quaternary ammonium materials present. Likewise, if there is any saturated quaternary ammonium materials present in the composition, the iodine value represents the mean iodine value of the parent acyl compounds of fatty acids of all of the quaternary ammonium materials present.

Iodine value as used in the context of the present invention refers to, the fatty acid used to produce the QAC, the measurement of the degree of unsaturation present in a material by a method of nmr spectroscopy as described in Anal. Chem., 34, 1136 (1962) Johnson and Shoolery.

A further type of softening compound may be a non-ester quaternary ammonium material represented by formula:

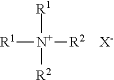

wherein each R1 group is independently selected from C1 to C4 alkyl, hydroxyalkyl or C2 to C4 alkenyl groups; R2 group is independently selected from C8 to C28 alkyl or alkenyl groups, and X-is as defined above.

The laundry composition preferably comprise one or more enzyme. Examples of suitable enzymes include, but are not limited to mannase, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, beta-glucanases, arabinosidases, hyaluronidase, chondroitinase, laccase, xantanase, carrageenases, pectate lyases, nucleases, phosphodiesterases, and amylases, or mixtures thereof. Preferred enzymes maybe selected from protease, lipase, amalayse, mannase, cellulase, and combinations thereof.

Examples of preferred enzymes are sold under the following trade names Purafect Prime®, Purafect®, Preferenz® (DuPont), Savinase®, Pectawash®, Mannaway®, Lipex®, Lipoclean®, Whitzyme® Stainzyme®, Stainzyme Plus®, Natalase®, Mannaway®, Amplify® Xpect®, Celluclean® (Novozymes), Biotouch (AB Enzymes), Lavergy® (BASF).

Preferably the level of an enzyme is from 0.1 to 200, more preferably from 0.5 to 150, even more preferably 1 to 120, most preferably from 5 to 110 mg active enzyme protein per 100 g laundry composition.

The laundry composition preferably comprises shading dyes. Shading dye can be used to improve cleaning. Preferred dyes are violet or blue. It is believed that the deposition on fabrics of a low level of a dye of these shades, masks yellowing of fabrics. A further advantage of shading dyes is that they can be used to mask any yellow tint in the composition itself. Suitable and preferred classes of dyes include direct dyes, acid dyes, hydrophobic dyes, basic dyes, reactive dyes and dye conjugates. Preferred examples are Disperse Violet 28, Acid Violet 50, anthraquinone dyes covalently bound to ethoxylate or propoxylated polyethylene imine as described in WO2011/047987 and WO 2012/119859, alkoxylated mono-azo thiophenes, dye with CAS-No 72749-80-5, acid blue 59, and the phenazine dye selected from:

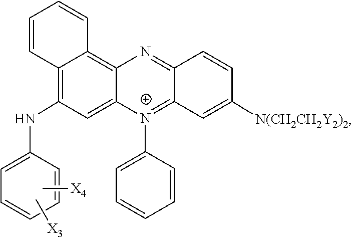

wherein:
X₃ is selected from: —H; —F; —CH₃; —C₂H₅; —OCH₃; and, —OC₂H₅;
X₄ is selected from: —H; —CH₃; —C₂H₅; —OCH₃; and, —OC₂H₅;
Y₂ is selected from: —OH; —OCH₂CH₂OH; —CH(OH)CH₂OH; —OC(O)CH₃; and, C(O)OCH₃.

Alkoxylated thiophene dyes are discussed in WO2013/142495 and WO2008/087497.

The shading dye is preferably present is present in the composition in range from 0.0001 to 0.1 wt %. Depending upon the nature of the shading dye there are preferred ranges depending upon the efficacy of the shading dye which is dependent on class and particular efficacy within any particular class.

Where present, the composition preferably comprises 0.0001 to 10 wt. % shading dye, more preferably 0.001 to 5 wt. %, most preferably 0.005 to 2 wt. % shading dye by weight of the composition.

The composition preferably comprise antibacterial agents. These ingredients provide reduction or prevention of bacterial on surfaces.

The laundry compositions described herein may comprise a dye for colouring the composition. Such dyes are commonly used in laundry compositions, examples include dyes marketed under the Liquitint tradename ex. Milliken.

The laundry compositions described here preferably comprise 50 to 99 wt. % water, by weight of the laundry composition. More preferably 65 to 98 wt. % water, more preferably 70 to 97 wt. % water, even more preferably 75 to 96 wt. % water, even more preferably 80 to 95 wt. % water, most preferably 85 to 95 wt. % water, by weight of the laundry composition.

The compositions produced by the method described herein may be in the form of particles, sheets, supplied in a unit dose package or any other suitable form for use in the laundry process. Preferably the compositions are in the form of particles or unit dose. Preferred unit dose packages comprise a water-soluble film such as PVOH or a non-soluble pack from which the consumer dispenses the contents. Particles are preferably defined as objects having a maximum linear dimension in any direction of 1 to 50 mm. The particles may be any suitable shape, for example spheres, hemispheres, cubes, oblongs, elliptical, or recognisable shapes such as leaves or flowers, such shapes are obtained from different shaped moulds. The particles may be supplied to the consumer alone or incorporated into another laundry product, such as a distinct particle in a liquid laundry composition or mixed into a laundry powder. Sheets refer to large thin composition, such compositions preferably have a maximum linear dimension of 300 mm, more preferably 200 mm and most preferably 150 mm. Such compositions preferably have a maximum depth of 3 mm, more preferably 2 mm, most preferably 1 mm.

Preferably the laundry composition is in the form of particles, the particles may be free flowing or packaged within a unit dose package. Preferably the particles have a maximum linear dimension in any direction of 1 to 40 mm, more preferably 1.5 mm to 30 mm and most preferably 2 mm to 20 mm.

The laundry compositions described herein may be used in any stage of the laundry process and may be used in hand washing or in a washing machine. Preferably the compositions are used in the wash stage of the laundry process. Preferably the compositions dissolve in less than 25 minutes.

The compositions described herein may be made by any suitable method. Generally, the composition may be made by:
i) mixing a salt curing composition with the other ingredients in the composition; or
ii) preparing a composition containing all ingredients other than the salt, then exposing this mixture to a salt curing solution.

When preparing particles, the following method may be followed.

Preferably a curing composition is prepared. For process i) the curing composition may simply comprise salt. Preferably the curing composition comprises water and salt. The solution preferably comprises salt in a concentration of 0.01 to 10 Molar, more preferably 0.05 to 5 Molar, even more preferably 0.01 to 4 Molar and most preferably 0.01 to 2.5 Molar.

Separately the hydrocolloid may be dispersed in water. The hydrocolloid solution is preferably prepared by dispersing the hydrocolloid in water. The hydrocolloid may be dispersed in water before heating, during heating the water or once the water has reached maximum heating temperature. The water or water and hydrocolloid are preferably heated to 40° C. to 100° C., more preferably 45° C. to 95° C. and most preferably 50° C. to 80° C. The concentration of hydrocolloid in water is preferably 0.1 to 10 wt. % by weight of the solution, more preferably 0.25 to 5 wt. % by weight of the solution, most preferably 1 to 2 wt. % by weight of the solution. All remaining ingredients maybe added to the solution, for example microcapsules, softening agents, dyes, etc. and thoroughly mixed. This mix is referred to as the hydrocolloid solution. It is preferred to disperse the hydrocolloid in water before adding any other ingredients, however the alternate order of addition is possible.

Following process i) the curing composition is mixed into the hydrocolloid solution. The curing composition may be added at any stage, however it is preferred that the curing composition is the last ingredient to be added. The curing composition is added to deliver the preferred quantity of salt. Once all ingredients are mixed, the mixture is dispensed (preferably dripped or poured) onto a surface or into a mould, where the solution solidifies and forms a particle. Preferably the mixture is at a temperature of 35° C. to 70° C., more preferably 40° C. to 60° C. and most preferably 45° C. to 50° C. when dropped onto a surface or into a mould. The temperature of the surface or mould is preferably 15° C. to 30° C., more preferably 17° C. to 27° C. The solidified composition is allowed to dry.

Process i) described herein may be carried out using any suitable equipment. On a small scale the method may be carried out manually using a pipette to dispense droplets of the composition onto a surface or into moulds. On a larger scale, traditional casting methods may be applied.

Following process ii) the hydrocolloid solution is dripped into the curing salt solution. Preferably the hydrocolloid solution is at a temperature of 35° C. to 70° C., more preferably 40° C. to 60° C. and most preferably 45° C. to 50° C. when dropped into the curing composition. The temperature of the curing composition is preferably 15° C. to 30° C., more preferably 17° C. to 27° C. The solidified beads are then removed from the curing composition and allowed to dry.

Process ii) described herein may be carried out using any suitable equipment. On a small scale the method may be carried out manually using a pipette to dispense droplets of the hydrocolloid solution into the curing composition. On a larger scale, the droplet formation may be by co-axial air flow, vibration such as a vibrating membrane, electrostatic interactions or mechanical cutting to break a liquid jet into droplets such as a cutting wheel. Manufacturers of suitable equipment include Nisco Engineering, geniaLab, and Maag Group under the trade name DROPPO®. Processes i) and ii) may be used in compositions where the benefit agent is dispersed in the hydrocolloid solution. Alternatively the benefit agent may be encapsulated by the hydrocolloid matrix. This may be preferable when the benefit agent is an oil or is in an organic solvent or carrier. For compositions where the oil is encapsulated in an aqueous phase, suitable encapsulation machines are available from Joysun, Fuji Capsule Co. and Sanco Technology.

### EXAMPLES

The effect of different salts was observed.

TABLE 1
Hydrocolloid compositions

| | wt. % active in composition |
|---|---|
| Carrageenan* | 1.8 |
| Free perfume | 7 |
| Encapsulated perfume | 2 |
| Dye | 0.0001 |
| Water | 89.2 |

*obtained in Europe

The compositions were prepared by dissolving the Carrageenan in the water at a temperature of 50-60° C. with stirring. The perfume microcapsules, free oil perfume and dye were added and stirred until homogeneous.

The curing solutions were prepared according to table 2 and placed in a petri dish.

The hydrocolloid composition was dropped into the curing solutions using a pipette. The resulting particles were removed from the curing solution and allowed to dry by placing on filter paper.

Dissolution was measured by the following method. Into a 2 litre beaker was placed a large magnetic stirrer and 1 litre of 25° C. water. The stirrer speed was adjusted to obtain a 4 cm vortex. 1.5 g of particles were added to the beaker and a timer started. The timer was stopped when the particles had fully dissolved. If the particles had not dissolved at 30 minutes, the timer was stopped and >30 mins recorded as the dissolution time.

TABLE 2
Results

| | Curing bath composition | Dissolution time | |
|---|---|---|---|
| A | 1M KCl | >30 | mins |
| B | 0.5M KCl | >30 | mins |
| C | 0.1M KCl | >30 | mins |
| D | 1M CaCl₂ | >30 | mins |
| E | 0.5M CaCl₂ | >30 | mins |
| F | 0.1M CaCl₂ | >30 | mins |
| 1 | 1M NaCl | 19 | mins |
| 2 | 0.5M NaCl | 20 | mins |
| 3 | 0.1M NaCl | 20 | mins |

The particles cured in sodium chloride had improved dissolution times.

1-13. (canceled)

14. A laundry composition comprising;
a. 0.5 to 5 wt. % hydrocolloid comprising carrageenan;
b. benefit agent;
c. salt comprising sodium chloride; and
d. 50 to 99 wt. % water,
wherein the laundry composition is in particle, sheet or unit dose form.

15. The laundry composition according to claim 14, wherein the composition comprises from 0.00001 to 3 wt. % salt.

16. The laundry composition according to claim 14, wherein the salt further comprises potassium chloride.

17. The laundry composition according to claim 14, wherein the composition comprises from 1 to 3 wt. % hydrocolloid.

18. The laundry composition according to claim 14 wherein the hydrocolloid further comprises polymers selected from agar, tragacanth, gum arabic, alginates, pectins, polyoses, guar flour, alginate, locust bean gum, starch, dextrins, gelatin and/or casein, xanthan gum, carboxymethyl cellulose, hydroxyethyl cellulose, hydroxypropyl cellulose or combinations thereof.

19. The laundry composition according to claim 14 wherein the hydrocolloid consists of carrageenan.

20. The laundry composition according to claim 14, wherein the composition comprises from 1.5 to 20 wt. % benefit agent.

21. The laundry composition according to claim 14, wherein the benefit agent comprises perfumes, perfume microcapsules, film forming polymers, fluorescers, dye-transfer inhibitors, natural oils, fabric softening actives, enzymes, shading dyes or combinations thereof.

22. The laundry composition according to claim 14, wherein the laundry composition comprises from 85 to 95 wt. % water.

23. The laundry composition according to claim 14, wherein the benefit agent comprises a dye transfer inhibitor.

24. The laundry composition according to claim 14, wherein the composition is in particle form having a maximum linear dimension in any direction of 1 to 50 mm.

25. The laundry composition according to claim 21, wherein the composition comprises 0.0001 to 10 wt. % shading dye.

26. The laundry composition according to claim 14, wherein the composition further comprises at least one natural oil which is olive oil, seed oil, algal oil or a mixture thereof.

27. The laundry composition according to claim 26 wherein the natural oil comprises almond, argan, babassu, borage, camelina, canola, castor, chia, cherry, coconut, corn, cotton, coffee, Cuphea viscosissima, linseed, grape, hemp, hepar, jatropha, jojoba, Lesquerella fendleri oil, Moringa oleifera oil, macadamia, mango, mustard, neem, oil palm, perilla, rapeseed, safflower, sesame, shea, stillingia, soybean, sunflower, tonka bean, tung or a mixture thereof.

28. A method of delivering benefit agents to fabric during a laundry process, wherein the laundry composition according to claim 14 is added to the laundry process.

29. The method according to claim 28 wherein, the benefit agent comprises perfume, perfume microcapsule, film forming polymer, fluorescer, dye transfer inhibitor, natural oil, fabric softening active, enzyme, shading dye or combinations thereof.

30. The method according to claim 28 wherein the laundry composition is in a unit dose package comprising water-soluble film.
